(19) United States
(12) Patent Application Publication
(10) Pub. No.: US 2002/0192625 A1
(43) Pub. Date: Dec. 19, 2002

(54) Monitoring device and monitoring system

(76) Inventor: Takashi Mizokawa, Shizuoka (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/173,451

(22) Filed: Jun. 13, 2002

(30) Foreign Application Priority Data
Jun. 15, 2001 (JP) 2001-181286

(51) Int. Cl. G09B 19/00

(52) U.S. Cl. 434/236

(57) ABSTRACT

A monitoring device includes a recognition device 102 for acquiring information on a surrounding environment to recognize the surrounding environment, an behavior control section 107 for producing an feeling based on the surrounding environment recognized by the recognition device 102 to determine an behavior based on the feeling produced by the feeling production means, and a mode switching section 103 for switching an autonomous mode and a monitor mode, and the behavior is determined according to a switching command by the mode control section 103.

### BACKGROUND OF THE INVENTION

1. Field of the Invention

This invention relates to a monitoring device and monitoring system for monitoring a given monitor area, for example, by patrolling the monitor area, and particularly to a monitoring device and monitoring system capable of decreasing a uncomfortable feeling given to a user.

2. Description of the Related Art

Conventionally, as a monitoring device, a monitor robot has been in use which patrols autonomously a given monitor area according to a predetermined setting.

In addition to the monitoring device, there has been a robot whose character changes according to external factors such as user's attitude to the robot and the environment, which is called a “pet robot,” and like a real pet, it has been accepted by a number of homes.

However, such a conventional monitoring device, though having a sufficiently high crime prevention effect, is an inorganic machine. Therefore, unlike the foregoing pet robot, such a machine gives an uncomfortable feeling to a user when patrolling, and has not been popularized sufficiently.

In view of the foregoing problem associated with the conventional monitoring device, it is an object of this invention to provide a monitoring device and monitoring system capable of decreasing an uncomfortable feeling given to a user.

### SUMMARY OF THE INVENTION

In an embodiment, the present invention provides a monitoring device comprising: (i) an environmental information-sensing unit for sensing information on a surrounding environment; (ii) an environmental information-processing unit for processing the information sensed by the environmental information-sensing unit, thereby recognizing the surrounding environment; (iii) an emotion-generating unit for generating emotions based on the surrounding environment recognized by the environmental information-processing unit; (iv) a mode-selecting unit for selecting an autonomous mode in which the device behaves autonomously or a monitoring mode in which the device monitors the surrounding environment; (v) a behavior-determining unit for determining a behavior in the selected mode based on the surrounding environment recognized by the environmental information-processing unit and the emotions generated by the emotion-generating unit; and (vi) a behavior-activating unit for activating the behavior determined by the behavior-determining unit. According to the embodiment, the device acts like a trained dog even when monitoring the environment.

In the above, the behavior-determining unit may be configured to transmit monitoring data in the monitoring mode when the emotions generated by the emotion-generating unit exceed pre-selected threshold levels.

In another embodiment, the device further comprises a monitoring condition-inputting unit for inputting monitoring conditions into the behavior-determining unit.

In yet another embodiment, the device further comprises a data-transmitting unit for transmitting monitoring data acquired by the environmental information-processing unit in the monitoring mode, to a memory or a designated place.

In still another embodiment, the device further comprises a communication interface for communicating with a designated user to accomplish at least one of the following: (a) receiving commands for the mode-selecting unit, (b) receiving commands for the mode-selecting unit, (c) receiving commands for the monitoring condition-inputting unit, and (d) transmitting the monitoring data.

For purposes of summarizing the invention and the advantages achieved over the prior art, certain objects and advantages of the invention have been described above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description of the preferred embodiments which follow.

### BRIEF DESCRIPTION OF THE DRAWINGS

These and other features of this invention will now be described with reference to the drawings of preferred embodiments which are intended to illustrate and not to limit the invention.

FIG. 1a is a block diagram showing a general construction of a monitoring system of an embodiment of this invention.

FIG. 1b is a block diagram showing another general construction of a monitoring system of an embodiment of this invention.

FIG. 2 is a flowchart of the operation of a control program executed in the monitor robot of FIG. 1b.

FIG. 3 is a flowchart of the monitoring behavior control processing executed in the operation of FIG. 2.

Symbols used in the figures are as follows: 1: Communication line; 2: Terminal device; 3: Monitor robot; 102: Recognition device; 103: Mode control section; 107: Behavior control section; 108: Behavior device control section.

### DETAILED DESCRIPTION OF THE PREFERRED EMBODIMENT

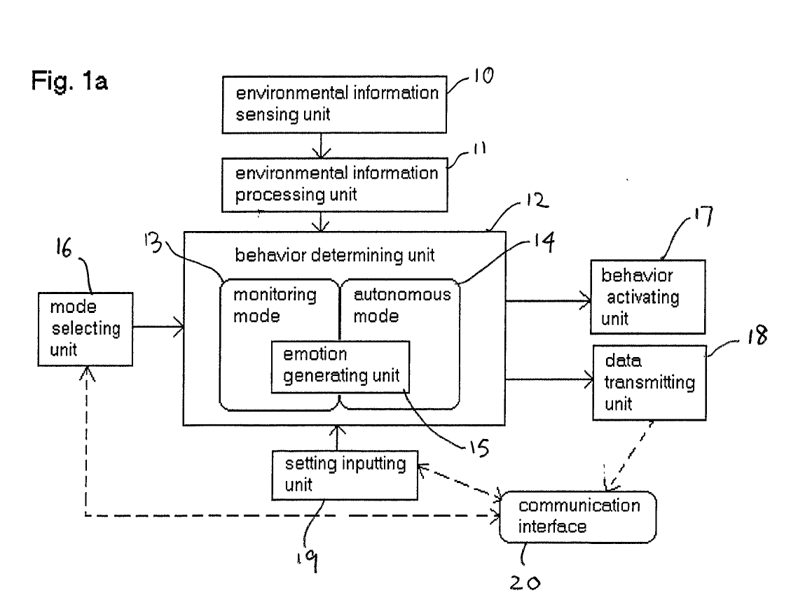

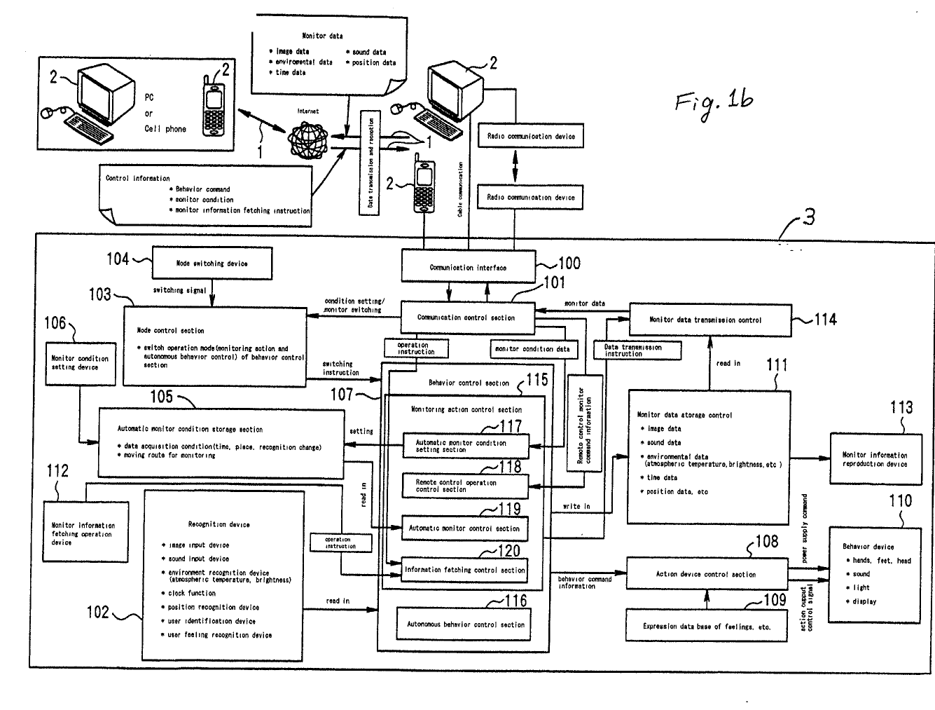

As shown in FIG. 1a, in an embodiment, a monitoring device comprises: (i) an environmental information-sensing unit 10 for sensing information on a surrounding environment; (ii) an environmental information-processing unit 11 for processing the information sensed by the environmental information-sensing unit, thereby recognizing the surrounding environment; (iii) an emotion-generating unit 15 for generating emotions based on the surrounding environment recognized by the environmental information-processing unit; (iv) a mode-selecting unit 16 for selecting an autonomous mode 14 in which the device behaves autonomously or a monitoring mode 13 in which the device monitors the surrounding environment; (v) a behavior-determining unit 12 for determining a behavior in the selected mode based on the surrounding environment recognized by the environmental information-processing unit and the emotions generated by the emotion-generating unit; and (vi) a behavior-activating unit 17 for activating the behavior determined by the behavior-determining unit.

The environmental information sensing unit 10 can be any suitable sensing systems including color, brightness, image, sound, smell, and/or tactile sensing systems. The environmental information processing unit 11 processes the information to identify the surrounding environment. The environmental information processing unit 11 accesses memory files so that a sensed object can be categorized (e.g., unknown objects, expected objects, marked objects, etc.).

The behavior determining unit 12 comprises the monitoring mode 13 and the autonomous mode 14, both of which are connected to the emotion generating unit 15. The emotion generating unit 15 modifies the behavior instructed for monitoring. Further, the behavior-determining unit 15 may be configured to transmit monitoring data in the monitoring mode when the emotions generated by the emotion-generating unit exceed pre-selected threshold levels. In this way, data can be screened based on the emotions so that the volume of compiled data can be reduced effectively. By using the emotions, the monitoring behavior can be deviated from the originally instructed course, so that if several events concurrently occur which reasonably create a suspicion of danger, the device can monitor the surrounding environment more carefully. This behavior control can be accomplished without using emotions by simply using a sequence control system comprehending all possible events and commanding the device to move under predetermined rules sequentially. However, if all possible occasions are memorized in the system, the capacity significantly increases, and control becomes very complicated. By using emotions, efficient and effective monitoring can be accomplished with simple algorithms.

Any suitable emotion control techniques can be adapted to this invention, including U.S. Pat. No. 6,175,772 (issued Jan. 16, 2001), U.S. Pat. No. 6,230,111 (issued May 8, 2001, and U.S. Pat. No. 6,249,780 (issued Jun. 19, 2001, and U.S. patent application Ser. No. 09/393,146 (filed Sep. 10, 1999), Ser. No. 09/393,247 (filed Sep. 10, 1999), and Ser. No. 09/394,369 (filed Sep. 10, 1999). The disclosure of each reference in its entirety is incorporated herein by reference.

The device may further comprise a monitoring condition-inputting unit 19 for inputting monitoring conditions into the behavior-determining unit. The mode selection can be done manually or programmed.

The device may further comprise a data-transmitting unit 18 for transmitting monitoring data acquired by the environmental information-processing unit in the monitoring mode, to a memory or a designated place. As described above, by using emotions, transmitted data volume can be significantly reduced.

The device may further comprise a communication interface 20 for communicating with a designated user to accomplish at least one of the following: (a) receiving commands for the mode-selecting unit, (b) receiving commands for the mode-selecting unit, (c) receiving commands for the monitoring condition-inputting unit, and (d) transmitting the monitoring data. The device can be an fully integrated device or can be equipped with a remote control system in which a control portion (e.g., the behavior determining unit 12, the mode selecting unit 16, the, the setting inputting unit 19, and optionally the environmental information processing unit 11) can be separated from a physically moving portion (e.g., the environmental information sensing unit 10 and the behavior activating unit 17). Further, by using an interface, communication can be established between a designated user and the mode selecting unit 16, the date transmitting unit 18, and/or the setting inputting unit 19 via the Internet.

In other aspects, the present invention includes the following embodiments:

1) A monitoring device characterized by comprising: environmental information acquisition means for acquiring information on a surrounding environment; environment recognition means for recognizing the surrounding environment based on the information acquired by the environmental information acquisition means; feeling production means for producing feelings based on the surrounding environment recognized by the environment recognition means; behavior determination means for determining a behavior based on the feeling produced by the feeling production means; and mode switching means for switching an autonomous mode and a monitor mode; and wherein said behavior determination means determines the behavior in response to the switching result of said mode switching means.

2) The monitoring device according to item 1, wherein in said monitor mode, said environmental information acquisition means acquires environmental information on an image, a sound or the like as information on said surrounding environment.

3) The monitoring device according to item 1 or 2, wherein said monitor mode includes an autonomous monitor mode in which monitoring is performed autonomously under predetermined monitor conditions, and a remote operation mode in which monitoring is performed according to user's remote operation.

4) The monitoring device according to item 3, comprising, in said remote operation mode, selection-of-behavior request means for requesting a user to select an behavior, and selected behavior determination means for determining an behavior based on the selection result selected by the user through said selection-of-behavior request means.

5) The monitoring device according to item 3 or 4, comprising monitor condition input means through which a user inputs said monitor conditions.

6) The monitoring device according to any of items 3-5, wherein said monitor conditions include at least one of a date, a time interval, a degree of change in the surrounding environment, and a patrol route.

7) The monitoring device according to any of items 1-6, wherein said switching means switches the autonomous mode and the monitor mode based on the recognition result by said environment recognition means.

8) The monitoring device according to any of items 1-7, comprising person identification information fetching means for fetching information on a voice, a face image or the like by which a person can be identified, from among surrounding environments recognized by said environment recognition means; and user identification means for determining, based on said information, whether or not a person whose information is fetched by the person identification information fetching means is a user who has been registered in advance; and wherein said behavior determination means determining an behavior based on the feeling produced by said feeling production means and the identification result by said user identification means.

9) The monitoring device according to any of items 1-8, comprising feeling identification information fetching means for fetching information on a voice, an expression or the like by which feelings can be identified, from among surrounding environments recognized by said environment recognition means; said behavior determination means determining an behavior based on the feeling produced by said feeling production means and the information fetched by said feeling identification information fetching means.

10) The monitoring device according to any of items 1-9, comprising, in said autonomous monitor mode, power saving means for stopping power supply to a given part according to monitor conditions.

11) The monitoring device according to any of items 1-10, comprising storage means for storing information on the surrounding environment recognized by said environment recognition means in said monitor mode; retrieval condition input request means for requesting a user to input retrieval conditions; and a presentation device for presenting the information stored in said storage means, based on retrieval conditions inputted by the user through the retrieval condition input request means.

12) The monitoring device according to any of items 1-11, comprising monitor information notification means for notifying monitor information as the recognition result by said environment recognition means in said monitor mode, to a user through a communication line.

13) The monitoring device according to any of items 1-12, comprising abnormality occurrence detection means for detecting occurrence of abnormality of a monitor object, based on monitor information as the recognition result of said environment recognition means in said monitor mode; and abnormality occurrence notification means for notifying a user that the abnormality occurrence detection means has detected occurrence of abnormality of the monitor object.

14) A monitoring system characterized by comprising a monitoring device and a server, said monitoring device comprising environmental information acquisition means for acquiring information on a surrounding environment; environment recognition means for recognizing the surrounding environment based on the information acquired by the environmental information acquisition means; feeling production means for producing an feeling based on the surrounding environment recognized by the environment recognition means; behavior determination means for determining an behavior based on the feeling produced by the feeling production means; mode switching means for switching an autonomous mode and a monitor mode; and transmission means for transmitting the monitor information recognized by said environment recognition means and identification information on a user corresponding to the monitor information, in said monitor mode, and said server comprising storage means for receiving, for storage, the monitor information transmitted by said transmission means and the identification information on the user; and presentation means for presenting monitor information corresponding to the user in response to a request of the user.

Therefore, the monitoring device according to the invention of item 1, in the autonomous mode, first acquires information on a surrounding environment and recognizes the surrounding environment based on the information. Then, it produces an feeling based on the surrounding environment and determines an behavior based on the feeling. Thus, in the autonomous mode, an behavior is determined based on an feeling, therefore the device behaves like a living thing, giving a friendly feeling to a user as if it were a pet, and in the monitor mode, a uncomfortable feeling given to the user is small even if it patrols autonomously a monitor area, for example, in the room.

Also, even in the monitor mode, the device may recognize a surrounding environment based on information on the surrounding environment, produce a feeling based on the surrounding environment, and determine an behavior based on the feeling, as in the autonomous mode. Even in the monitor mode, it determines an behavior based on an feeling and behaves like a living thing, so that when a person other than the user intrudes into a monitor area, for example, it can make a motion of surprise to the intruder or a motion threatening the intruder to give the intruder a sensation that it might be a watch dog and to thereby frighten the intruder, improving a crime prevention effect.

Further, in the case where storage means is provided for storing information on a surrounding environment, the amount of information becomes enormous if in the monitor mode, all the monitor information is to be stored by the storage means, but the amount of monitor information to be stored can be decreased if the monitor information is stored only when a certain feeling change happens or if the monitor information is stored according to the level of the feeling.

Also, the monitoring device according to the invention of item 2 is adapted, in the monitor mode, to acquire environmental information on an image, a sound or the like as information on the surrounding environment. Therefore, when a suspicious sound is heard in the monitor area, it can produce an feeling of “interest” and move immediately to a spot where the suspicious sound is heard, even in the midst of patrolling the monitor area following a predetermined route, providing a flexible response to the change in the surrounding environment.

Further, in the monitoring device according the invention of item 3, the monitor mode includes a remote operation mode in which monitoring is performed according to user's remote operation. Therefore, a desired monitor object can be monitored at all times regardless of predetermined monitor conditions such that if a user becomes anxious about whether or not he locked the door before leaving home, for example, he can operate the monitoring device to check the door key.

Also, in the monitoring device according to the invention of item 4, in the remote operation mode, an behavior is selected by a user and determined based on the selected result. Therefore, when intruder is found in the remote operation mode, for example, the device can make a motion such as threatening or the like easily if only the user selects the motion.

By the way, methods to input the monitor conditions include a method in which monitor conditions are inputted by a user through a cell phone, a PC or the like, as in the invention of item 5.

Also, the monitor conditions include a date, a time interval, a degree of change in the surrounding environment, a patrol route or the like, as in the invention of item 6.

Further, in the monitoring device according to the invention of item 7, an autonomous mode and a monitor mode are switched based on the surrounding environment such that operation is switched to the monitor mode in the evening when it becomes dark in the surrounding area and to the autonomous mode in the morning when it becomes light. Therefore, the user need not care about switching of the mode, and even if in the monitor mode the device patrols autonomously the monitor area, for example, in the room, a uncomfortable feeling given to the user can be decreased to a small degree.

Also, in the monitoring device according to the invention of item 8, information on a voice, a face image or the like by which a person can be identified, is fetched from among the recognized surrounding environments, it is determined based on the information whether or not the person is a user who has been recognized in advance, and an behavior is determined based on the identification result and the feeling. Therefore, a different behavior is performed, depending on whether or not the person is the user when an intruder is found in the monitor area for example, and a behavior such as threatening is performed if the intruder is a person other than the user who has been registered in advance.

Further, in the monitoring device according to the invention of item 9, information on a voice, an expression or the like by which an feeling can be identified, is fetched from among the recognized surrounding environments, and an behavior is determined based on the information and the feeling. Therefore, if a person other than the user is found intruding into the monitor area, an behavior is performed such that the intruder has a feeling of fright, improving a crime prevention effect.

Also, in the monitoring device according to the invention of item 10, power supply to a given part is stopped according to the monitor conditions. Therefore, power supply to sensors not in use for monitoring can be stopped so as to reduce power consumption without influence to the monitoring. Thus, if the device is operated by a built-in power source such as a battery, for example, the length of time that the device can be operated for one charging of the battery, can be increased.

Further, in the monitoring device according to the invention of item 11, information on the surrounding environment is stored in said monitor mode, and retrieval conditions are inputted by a user through a cell phone, a PC or the like to present the information based on the retrieval conditions to the user. Therefore, the user can obtain desired information from among an enormous amount of information if only he inputs the retrieval conditions.

Also, in the monitoring device according to the invention of item 12, the monitor information as the recognition result of said environment recognition means in said monitor mode, is notified to a user through a given communication line such as a telephone line, the internet or the like. Therefore, the user can learn immediately whether or not abnormality has occurred in the monitor area.

As monitor information to be notified to a user, all the monitor information in the monitor mode may be notified, but this results in an enormous amount of information. Therefore, if the monitor information is notified when change in a specific feeling is effected or when the specific feeling exceeds a predetermined level, the amount of monitor information to be notified can be preferably decreased.

Further, in the monitoring device according to the invention of item 13, when it is detected based on monitor information in said monitor mode that abnormality of a monitor object has happened, the fact is notified to a user. Therefore, the user can learn immediately that abnormality of the monitor object has happened.

Also, utilizing the monitoring device according to the invention of item 1, in the monitoring system according to this invention of item 14, the monitoring device transmits monitoring information and identification information on a user corresponding to the monitor information in the monitor mode, and a server provided in a company or an agency of crime prevention service receives to storage the transmitted monitor information and identification information on a user and presents the monitor information corresponding to the user in response to a request of the user issued through the internet or the like. Therefore, the user can learn the monitor information easily.

The present Invention includes, but is not limited to, the following embodiments:

Now, an example will be described below with reference to the drawings of a monitoring system for monitoring a house during a person's absence, embodying the monitoring device of this invention.

FIG. 1b is a block diagram showing the general construction of a monitoring system of an embodiment of this invention.

The monitoring system of the embodiment of this invention, as shown in FIG. 1b comprises a terminal device 2 (PC, cell phone, etc) connectable to a given communication line 1 (internet, etc), and a monitor robot 3 having a communication interface 100 connectable to the terminal device 2 through radio communication or the like.

A system user can transmit to the monitor robot 3 control information (behavior information, monitor conditions (date, time sensation, degree of change in the surrounding environment, patrol route, etc), monitor information fetching command, etc) and receives monitor data (image data, sound data, position data, time data, etc) from the monitor robot 3 through operation of the terminal device 2.

The monitor robot 3 comprises a communication control section 101, a recognition device 102, a mode control section 103, a mode switching device 104, an automatic monitor condition storage section 105, a monitor condition setting device 106, an behavior control section 107, an behavior device control section 108, an expression data base 109 for feelings or the like, an behavior device 110, a monitor data storage section 111, a monitor information fetching operation device 112, a monitor information reproduction device 113, and a monitor data transmission control 114, and the upper part of which has an external form in imitation of an upper half of a human body and the lower part of which has a plurality of wheels for movement.

The behavior control section 107 comprises a monitoring behavior control section 115 and an autonomous behavior control section 116, and further, the monitoring behavior control section 115 comprises an automatic monitor condition setting section 117, a remote operation control section 118, an automatic monitoring control section 119, and an information fetching control section 120.

First, the communication control section 101 receives control information or the like transmitted from the terminal device 2, to input them to the mode control section 103, automatic monitor condition setting section 117, remote operation control section 118, and information fetching control section 120.

The recognition device 102 includes an image input device, a sound input device, an environment recognition device (temperature, brightness, etc), a clock function, a position recognition device, a user identification device, and a user feeling recognition device provided in the head section, to input the output of these devices to the behavior control section 107. In the user feeling recognition device, voice analysis (analysis of frequency distribution and pitch of the voice) and expression analysis (analysis to determine the shape of eyes and the mouth) are performed from the voice information and the expression inputted from the voice input device and image input device, to estimate the person's feeling detected by the sound input device or the like, from the features of the voice information and expression information obtained from the analyzation result. The person's feeling is estimated based on a fuzzy inference or a given logic using a predetermined rule.

The mode control section 103 produces a switching command for switching an autonomous mode in which the device operates as a pet robot and a monitor mode in which the device operates as a monitoring device, based on a switching signal inputted from the mode switching device 104 for directly issuing a switching command of the operation mode to a system user and a switching signal transmitted from the terminal device 2 and inputted from the communication control section 101, to input them to the behavior control section 107.

On the other hand, the automatic monitor condition setting section 117 produces a setting signal based on monitor condition data transmitted from the terminal device 2 and inputted from the communication control section 101, to input it to the automatic monitor condition storage section 105.

The automatic monitor condition storage section 105 produces to store data acquisition conditions (time, place and recognition change) or a moving route for monitoring, based on a setting command inputted from the monitor condition setting device 106 through which a system user directly sets the monitor conditions or a setting signal inputted from the automatic monitor condition setting section 117 and cause the automatic monitoring control section 119 of the behavior control section 107 to read it. In order to produce the data acquisition conditions or the moving route, any method may be used, and for example, information on the monitor route may be inputted from the terminal device 2 by the system user to be transmitted as monitor conditions and produced them based on the transmitted information. Alternatively, the robot may be remotely operated by the system user through the terminal device 2, the information acquired during the remote operation is stored in the terminal device 2, and the information is transmitted as monitor condition data to produce them based on the transmitted information.

The behavior control section 107 produces behavior command information based on the recognition result inputted from the recognition device 102, a switching command inputted from the mode control section 103, data acquisition conditions read from the automatic monitor condition storage section 105, or the like to input it to the behavior device control section 108. The produced behavior command information includes moving speed information, steering information, information on head's orbit (information on the direction of camera), a reading command of monitor data, a writing command to the monitor data storage section, information on abnormal conditions (emission of loud noise, finding of person, etc), monitoring behavior information at the time of occurrence of abnormality, and the like.

As a method of producing the behavior command information, first, an initial monitor point is set as a target monitor point when the monitoring start time is reached. Then, the robot is run along a monitor route toward the target monitor point. If a signal corresponding to abnormality conditions is inputted from the recognition device 102 during running, the vehicle is stopped and after a predetermined monitoring behavior (for example, capturing image information with a camera turned round), running of the robot toward the target point is resumed.

Further, the behavior device control section 108 produces an behavior output control signal and a power supply command based on behavior command information inputted from the behavior control section 107 and an expression data base 109 of feelings or the like, to input them to the behavior device 110 comprised of motors for driving joints, a sound generator, a light generator, a display and the like.

The produced behavior output control signals include signals for driving output devices, such as duty control signals to the motors for driving joints and wheels, and signals of the kind, length and loudness of sounds to the sound generator. Also, the power supply signals include signals for instructing power supply to I/O devices, such as a power supply signal for instructing power supply to a motor controller for controlling motors, a power supply signal for instructing power supply to sensors forming the recognition device 102, and a power supply signal for instructing power supply to the sound generator.

At the same time, the behavior device control section 108 produces a reading command of monitor data to read the monitor data from the recognition device 102 as well as produces a writing command of the monitor data to store, in the monitor data storage section 111, image data, sound data, environmental data (atmospheric temperature, brightness, etc), time data, position data, or the like as the recognition result of the recognition device 102.

Further, the information fetching control section 120 of the monitoring behavior control section 15 produces a data transmission command for allowing the monitor data transmission control 114 to read the monitor data, based on the operating command inputted from the monitor information fetching operation device 112 operated by a user or the operating command inputted from the communication control section 101, to input it to the monitor data transmission control 114.

The operating commands inputted by the system user include a command (0: no operation, and 1: monitor data transmission) indicative of a data transmission command, the kind of monitor data to be transmitted (1: image data, 2: sound data, and 3: environmental data), and a location of the monitor data (0: latest data, 1: the preceding monitor data, and 2: monitor data ahead of the preceding monitor data), and the information fetching control section 120 produces a data transmission command when these operating command are inputted.

Also, the monitor data transmission control 114 reads monitor data from the monitor data storage section 111 to input it to the communication control section 101, based on the data transmission command inputted from the monitoring behavior control section 115 and to input the monitor data from the monitor data storage section 111 to the monitor information reproduction device 113.

The communication control section 101 transmits the monitor data inputted from the monitor data transmission control 114 to the terminal device 2 through the communication interface 100, and the monitor information reproduction device 113 reproduces the monitor data inputted from the monitor data storage section 111.

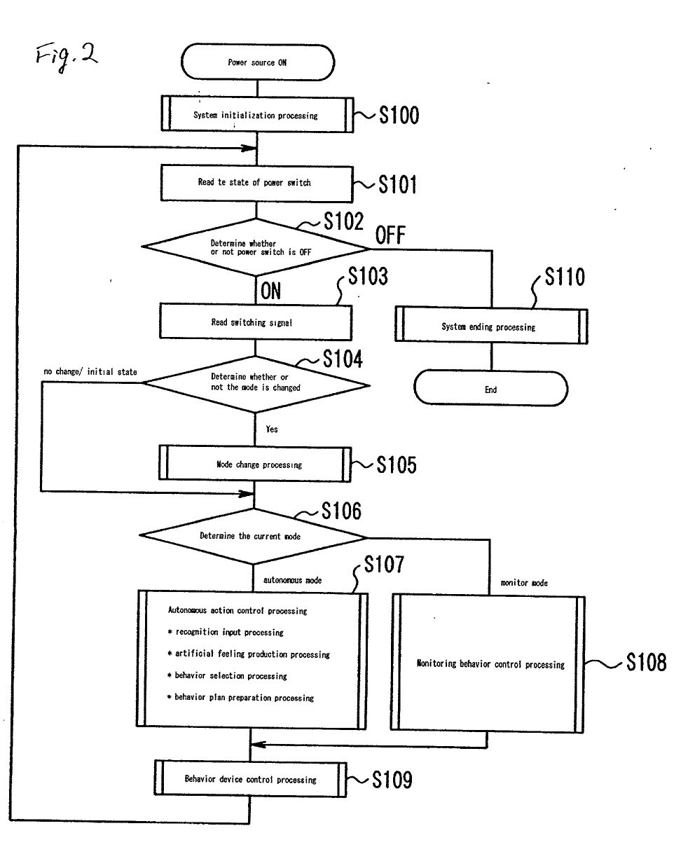

Now, description will be made on a control program to be executed when power switch is turned ON. The aim of the operation of this control program is to operate the monitor robot 3, and first, procedure proceeds to step S100, as shown in FIG. 2.

At step S100, system initialization processing is executed: an initial value is written in the monitor data storage section 111; the I/O state of the communication interface 100 is set to an initial state; and the behavior device 110 is set to an initial position, and then procedure proceeds to step S101.

At the step S101, the state of the power switch is read in, and procedure proceeds to step S102.

At the step S102, it is determined whether or not the power switch is OFF, based on the state of the power switch read at the step S101, and if the power switch is OFF, procedure proceeds to “OFF” step S110, and if not, to “ON” step S103.

At the step S103, the switching signal outputted from the mode switching device 104 and the switching signal outputted from the terminal device 2 are read in, and procedure proceeds to step S104.

At the step S104, it is determined whether or not the operation mode is changed, based on the switching signal read at the step S103, and if the operation mode is changed (“changed”), procedure proceeds to step S105, and if not (“no change/initial state”), to step S106 without any processing.

At the step S105, mode change processing is executed to change a mode flag indicative of the current operation mode, and then procedure proceeds to the step S106. Regarding the mode flag, mode flag 0 corresponds to an autonomous mode: mode flag 1 to an autonomous monitor mode; mode flag 2 to a remote control monitor mode; mode flag 3 to a monitor condition setting mode; and mode flag 4 to an information fetching mode, and each control section determines the processing to be executed by referring to the numeral.

At the step S106, the current operation mode is determined based on the switching signal read at the step S103, and if it is an autonomous mode, procedure proceeds to “autonomous mode” step S107, and if a monitor mode, to “monitor mode” step S108.

At the step S107, autonomous behavior control processing is executed, and then procedure proceeds to step S109. In the autonomous behavior control processing, an artificial feeling is produced from information read in from the recognition device 102, and movement of hands and feet or production of voices are executed successively according to the kind of behavior corresponding to the state of the feeling or the input from the user (taking hand, stroking head, calling name, waving hand, etc), the character and the growth stage.

On the other hand, at the step S108, after monitoring behavior control processing (described later) is executed, procedure proceeds to the step S109.

At the step S109, after behavior device control processing is executed, procedure proceeds to the step S101 again.

On the other hand, at the step S110, system termination processing is executed, and after the behavior device 110 is returned to a given position and the date is written in a non-volatile memory, power sources of control sections are switched OFF to ensure the safety when the power switches are turned ON next time, and then procedure of the program is terminated.

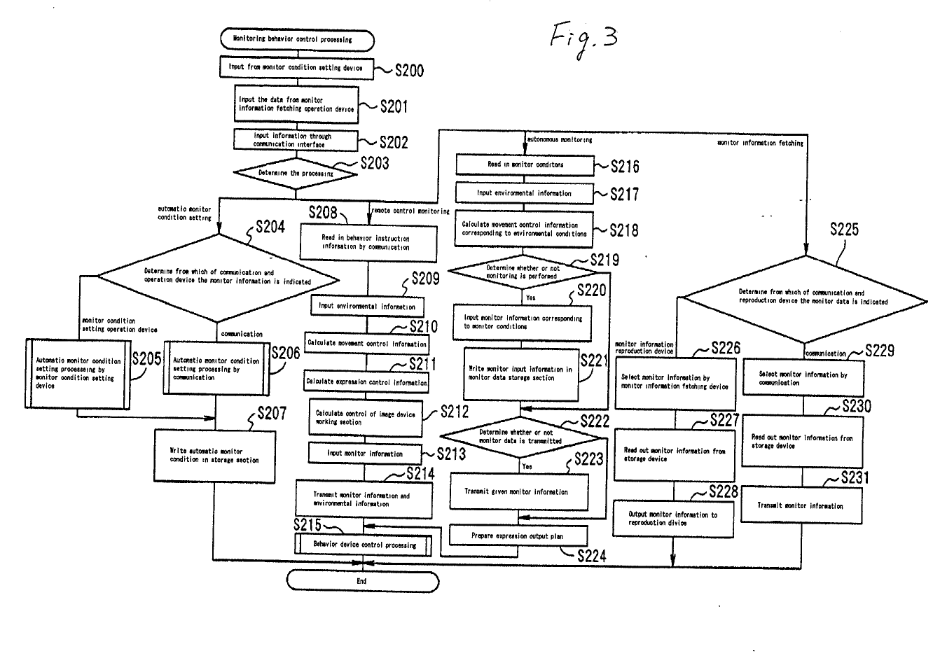

Now, referring to the flowchart of FIG. 3, detailed description will be made on the monitoring behavior control processing to be executed at step S108 of the operation of the control program.

First, at step S200, a setting signal is read in from the monitor condition setting device 106, and procedure proceeds to step S201.

At the step S201, an operation command is read in from the monitor information fetching operation device 112, and procedure proceeds to step S202.

At the step S202, the information transmitted from the terminal device 2 is read in through the communication interface 100, and procedure proceeds to step S203.

At the step S203, processing to be executed is determined by reference to the mode flag, and procedure proceeds to “automatic monitor condition setting” step S204 when monitor conditions are set; to “remote monitoring” step S208 when remote monitoring is performed; to “autonomous monitoring” step S216 when autonomous monitoring is performed; and to “fetching” step S225 when fetching of monitor data is performed.

At the step S204, it is determined from which of the terminal device 2 and the monitor condition setting device 106 monitor conditions are inputted by a system user, based on the setting signal read from the step S200 or the step S202, and procedure proceeds to “monitor condition setting operation device” step S205 when it is inputted from the monitor condition setting device 106, and to “communication” step S206 when it is inputted from the terminal device 2. The monitor conditions inputted by the system user include the monitoring position, the kind (image, sound, etc) of information monitored, for storage, at the monitoring position, the way of moving the head during monitoring, determination conditions of occurrence of abnormality (sound level, presence of person, etc), and the monitoring interval (time, etc).

At the step S205, after automatic monitor condition setting processing is executed for setting monitor conditions based on the output of the monitor condition setting device 106, procedure proceeds to step S207. In the automatic monitor condition setting processing, the output value of the monitor condition setting device 106 which may be an ON/OFF signal of a switch or a value of a variable resistor is converted into information indicative of predetermined monitor conditions to be written in the automatic monitor condition storage section 105.

On the other hand, at the step S206, after monitor condition setting processing is executed for setting monitor conditions based on information transmitted from the terminal device 2, procedure proceeds to the step S207. The monitor condition setting processing fetches monitor conditions from the monitor condition groups received from the terminal device 2 and writes them in the automatic monitor condition storage section 105.

At the step S207, the monitor conditions set at the step S205 or S206 are stored in the automatic monitor condition storage section 105, and the monitoring behavior control processing is terminated.

On the other hand, at the step S208, the behavior command information transmitted from the terminal device 2 is read in, and procedure proceeds to step S209.

At the step S209, environmental data is acquired from the recognition device 102 or an environment recognition device, and procedure proceeds to step S210.

At the step S210, monitoring control information (moving speed, amount of steering) is calculated based on the behavior command information read in at the step S208 and the environmental data acquired at the step S209, and procedure proceeds to step S211.

Regarding a method of calculating the movement control information, the current position is calculated by the dead reckoning method from the amount of rotation of the left and right wheels, and the amount of steering to a predetermined target point is determined, for running. When the recognition device 102 detects an obstacle, a detour is calculated from its size and position to calculate the amount of steering. If the device comes close up to a distance at which it is unable to avoid the obstacle simply by steering, it stops temporarily, and after moving back by a distance enabling it to avoid the obstacle, the detour is calculated again to determine the amount of steering, and the device resumes running.

At the step S211, expression control information for the expression corresponding to behavior command information is calculated based on the behavior command information read in at the step S204 and the environmental data acquired at the step S209, and procedure proceeds to step S212. For example, when an expression of “threatening” is instructed in the behavior command information, movement of the behavior device 110 is calculated such that the device gives out a growl from the sound generator and moves forward with its arms spread wide laterally and swung up and down.

At the step S212, the amount of control is calculated for a motor in an image device working section that changes the direction of the image input device, and procedure proceeds to step S213.

At the step 213, monitor data is acquired from the recognition device 102 to be stored in the monitor data storage section 111, and procedure proceeds to step S214.

At the step S214, monitor data and environmental data are transmitted to the terminal device 2, and procedure proceeds to step S215.

At the step S215, behavior device control processing is executed for producing a signal to be inputted to a motor of the behavior device 110, the sound output device, or the like, based on the monitoring control information calculated at the step S210 and the expression control information calculated at the step S211, and then the monitoring behavior control processing is terminated.

On the other hand, at the step S216, monitor conditions are read in from the automatic monitor condition storage section 105, and procedure proceeds to step S217.

At the step S217, environmental data is acquired from the recognition device 102 or an environmental recognition device, and procedure proceeds to step S218.

At the step S218, movement control information corresponding to the monitor conditions read in at the step S216 is calculated based on the environmental data acquired at the step S217, and procedure proceeds to step S219.

At the step S219, it is determined whether or not monitoring is performed to store monitor data in the monitor data storage section 111, and if monitoring is performed, procedure proceeds to “implementation” step S220, and if not, to step S222 without any processing.

Regarding a method of determining whether or not monitoring is performed, for example, implementation may be determined when the current position reaches a predetermined monitor point, or when environmental data (detection of person, emission of noise) coincides with predetermined monitor conditions. If monitor data is written in the monitor data storage section 111 at certain time intervals, implementation may be determined when the specified time is reached.

At the step S220, monitor data corresponding to monitor conditions is acquired from the recognition device 102, and procedure proceeds to step S221.

At the step S221, monitor data acquired at the step S220 is stored in the monitor data storage section 111, and procedure proceeds to step S222.

At the step S222, it is determined whether or not transmission conditions set by a system user are satisfied and the monitor data acquired at the step S220 is transmitted to the terminal device 2, and if it is transmitted, procedure proceeds to “implementation” step S223, and if not, to step S224.

At the step S223, the monitor data acquired at the step S220 is transmitted to the terminal device 2, and procedure proceeds to step S224.

At the step S224, an expression output plan is prepared based on an expression pattern corresponding to predetermined environmental data, and then procedure proceeds to step S215.

For example, in order for the device to perform an expression pattern of “threatening” when a person is detected, an expression output plan is prepared in which the device gives out a growl from the sound generator and moves forward with its arms spread wide laterally and swung up and down. Also, in order for the device to perform an expression pattern of “caution” when a loud noise is emitted, an expression plan is prepared in which the device gives out an alarm from the sound generator and moves forward slowly with its head turned round.

In addition, at the step S225, it is determined which of the terminal device 2 and the monitor information reproduction device 113 reproduces the monitor data, and if the monitor information reproduction device 113 reproduces the monitor data, procedure proceeds to “monitor information reproduction device” step S226, and if the terminal device reproduces the monitor data, to “communication” step S229. Regarding a method of determining the device reproducing the monitor data, when a switch instructing the start/end of fetching operation of the monitor information fetching operation device 112 is in the state of the start of fetching, it is determined that the monitor data is reproduced by the monitor information reproduction device 113. Also, when a “monitor information fetching start command” is transmitted from the terminal device 2, it is determined that the monitor data is reproduced by the terminal device 2.

At the step S226, the selection result of the monitor data selected by a system user from the monitor information fetching operation device 112 is read in, and procedure proceeds to step S227.

At the step S227, the monitor data selected at the step S226 is read out from the monitor data storage section 111, and procedure proceeds to step S228.

At the step S228, the monitor data read out at the step S227 is outputted to the monitor information reproduction device 113, and the monitoring behavior control processing is terminated.

On the other hand, at the step S229, the monitor information fetching command from the terminal device 2 is read in, and procedure proceeds to step S230.

At the step S230, monitor data is read out from the monitor data storage section 111, based on the monitor information fetching command read in at the step S229, and procedure proceeds to step S231.

At the step S231, the monitor data read out at the step S230 is transmitted to the terminal device 2, and the monitoring behavior control processing is terminated.

Now, operations of the monitoring system of this embodiment will be described in detail in connection with specific situations.

First, assuming that soon after a system user purchased the monitor robot 3, the power switch is turned ON, while the mode switching device 104 is instructing switching to an autonomous mode. Then, system initialization processing is executed at step S100; the state of the power switch is read in at step S101; and it is determined at step S102 that the power source is ON. Then, a switching signal is outputted from the mode switching device 104 to be read in at step S103; it is determined at step S104 that there is no mode change; it is determined at step S106 that the current operation mode is an autonomous mode; autonomous behavior control processing is executed at step S107 and an behavior is determined based on an feeling; and behavior device control processing is executed at step S109; and then the foregoing flow is executed repeatedly from the step S101 again.

Thus, in the autonomous mode, an behavior is determined based on an feeling, therefore the device behaves like a living thing, giving a friendly feeling to a user as if it were a pet, and in the monitor mode, a uncomfortable feeling given to the user is small even if it patrols autonomously a monitor area, for example, in the room.

Assuming that when the foregoing flow was being executed repeatedly, the system user happened to go out, so that he gave a switching command to the monitor mode through the mode switching device 104 as well as an operation command through the monitor information fetching operation device 112. Then, after the processing at steps S101-S103, it is determined at the step S104 that there is a mode change; mode change processing is executed at step S105; it is also determined at the step S106 that the current operation mode is a monitor mode; and monitoring behavior control processing is executed at step S108.

When the monitoring behavior control processing is executed, a setting signal is read in from the monitor condition setting device 106 at step S200; an operation command is read in from the monitor information fetching operation device 112 at step S201; information transmitted from the terminal device 2 is read in through the communication interface 100 at step S202; it is determined at step S203 that setting of monitor conditions is selected; automatic monitor condition setting processing is executed at step S205; the monitor conditions are stored in the automatic monitor condition storage section 105 at step S207; and the monitoring behavior control processing is terminated.

When the monitoring behavior control processing is terminated, procedure is returned to the operation of the control program, and after the processing at the step S109, the foregoing flow is executed from the step S101 again. Like the foregoing flow, after the processing at the steps S101-S202, it is determined at the step S203 that autonomous monitoring is selected; monitor conditions are read in from the automatic monitor condition storage section 105 at step S216; environmental data is acquired from the recognition device 102 or an environment recognition device at step S217; and at step S218, movement control information corresponding to monitor conditions read in at the step S216 is calculated based on the environmental data acquired at the step S217.

When it is determined at step S219 that monitoring is performed, monitor data corresponding to monitor conditions is acquired from the recognition device 102 at step S220, and at step S221, the monitor data acquired at the step S220 is stored in the monitor data storage section 111. When it is determined at step S222 that no monitor data is transmitted to the terminal device 2, an expression output plan is prepared at step S224, and after behavior device control processing is executed at step S215, the monitoring behavior control processing is terminated.

When the monitoring behavior control processing is terminated, procedure is returned to the operation of the control program, and after the processing at the step S109, the foregoing flow is executed repeatedly from the step S101 again.

Assuming that a user who left home becomes anxious about whether or not he or she locked the door key and sends control information to the monitor robot 3 through the terminal device 2 or a PC from a remote place. Then, after the processing at the steps S101-S106, monitoring behavior control processing is executed at step S108, and after the processing at steps S200-S202, it is determined at step S203 that it is remote monitoring.

When, at step S208, the behavior command information transmitted from the terminal device 2 is read in; at step S209, environmental data is acquired from the recognition device 102 or an environment recognition device; and at step S210, movement control information is calculated based on the behavior command information read in at the step S208 and the environmental data acquired at the step S209. Also, at step S211, an expression control information is calculated based on the behavior command information read in at the step S208 and the environmental data acquired at the step S209, and control of the image device working section is calculated at step S212. Then, at step S213, monitor data is acquired from the recognition device 102; at step S214, the monitor data and the environmental data are transmitted to the terminal device 2; and after behavior device control processing is executed at step S215, the monitoring behavior control processing is terminated.

As described above, since in the monitor mode, monitoring can be performed according to the remote operation of a user, a desired monitor object can be monitored at all times regardless of predetermined monitor conditions.

Also, assuming that a user who left home becomes anxious about the condition of his house and sends control information to the monitor robot 3 through the terminal device 2 or a PC from a remote place. Then, after the processing at the steps S101-S106, monitoring behavior control processing is executed at step S108, and after the processing at steps S200-S202, it is determined at step S203 that fetching of monitor data is executed. Then, at the step S225, it is determined that reproduction is performed by the terminal device 2; at step S229, monitor information fetching command is read in from the terminal device 2; at step S230, monitor data is read out from the monitor data storage section 111, based on the monitor information fetching command read in at the step S229; at step S231, the monitor data read out at the step S230 is transmitted to the terminal device 2; and then the monitoring behavior control processing is terminated.

In this embodiment, the environment information acquisition means and the environment recognition means correspond to the recognition device 102; the feeling production means and the behavior determination means correspond to the behavior control section; and the mode switching means corresponds to the mode control section.

Although this embodiment has been exemplified by an example of a monitoring system according to this invention, it is understood that the kind of monitor data or the like is not limited.

For example, although in the foregoing embodiment, an example has been shown in which an behavior is determined based on an feeling in an autonomous mode, even in a monitor mode, the device may determine an behavior based on an feeling, as in the autonomous mode, and behave like a living thing. In this case, when a person other than the user intrudes into a monitor area, for example, the device can make a motion of surprise to the intruder or a motion threatening the intruder to give the intruder a sensation that it might be a watch dog and to thereby frighten the intruder, improving a crime prevention effect.

In addition, if an behavior is determined based on an feeling even in the monitor mode, monitor data can be stored only when a certain feeling change happens or the monitor data can be stored according to the level of the feeling, so that the amount of monitor data to be stored in the monitoring data storage 111 can be decreased. Further, when a suspicious sound is heard in the monitor area, the device can produce an feeling of “interest” and move immediately to a spot where the suspicious sound is heard, even in the midst of patrolling the monitor area following a predetermined route, providing a flexible response to the change in the surrounding environment.

Furthermore, although an example has been shown in which an behavior command as control information is inputted by a system user from the terminal device 2, any method may be used to input the behavior command by the system user from the terminal device, and behavior selection may be performed in advance to determine an behavior based on the selected result. For example, when intruder is found in the remote operation mode, the device can make a motion such as threatening or the like easily if only the user selects the motion.

Also, although an example has been shown in which the behavior mode is switched according to operation of a system user, an autonomous mode and a monitor mode may be switched based on the surrounding environment such that operation is switched to the monitor mode in the evening when it becomes dark in the surrounding area and to the autonomous mode in the morning when it brighten up. In this case, the user need not care about switching of the mode, and even if in the monitor mode the device patrols autonomously the monitor area, for example, in the room, an uncomfortable feeling given to the user can be decreased to a small degree.

Further, although an example has been shown in which an behavior is determined based on the recognition result of the recognition device 102, information on a voice, a face image or the like by which a person can be identified, in particular, may be fetched among the recognized surrounding environments to determine whether or not the person is a user based on the information and to determine an behavior based on the identification result and the feeling. In this case, a different behavior can be performed, depending on whether or not the person is the user, such that when an intruder is found in the monitor area, for example, a behavior such as threatening is performed if the intruder is a person other than the user. Alternatively, information on a voice, an expression or the like by which an feeling can be identified may be fetched among the recognized surrounding environments to determine an behavior based on the information and the feeling, so that, if a person other than the user is found intruding into the monitor area, an behavior can be performed such that the intruder has a feeling of fright, and a crime prevention effect can be improved.

Further, if power supply to a given part is stopped according to the monitor conditions, power supply to sensors not in use for monitoring can be stopped so as to reduce power consumption without influence to the monitoring. Thus, when the device is operated by a built-in power source such as a battery, for example, the length of time that the device can be operated for one charging of the battery can be increased.

Furthermore, although an example has been shown in which a monitor information fetching command is inputted as control information by a system user from the terminal device 2, retrieval conditions may be inputted by a user through a cell phone, a PC or the like to present the information based on the retrieval conditions to the user, in which case, the user can obtain desired information from among an enormous amount of information if only he inputs the retrieval conditions.

Also, the monitor data as the recognition result of said environment recognition means in said monitor mode may be notified to a user through a given communication line such as a telephone line, the internet or the like, so that the user can learn immediately whether or not abnormality has happed in the monitor area. As monitor data to be notified to a user, all the monitor data in the monitor mode may be notified, but this results in an enormous amount of information. Therefore, if the monitor data is notified when change in a specific feeling is effected or when the specific feeling exceeds a predetermined level, the amount of monitor data to be notified can preferably be decreased.

Further, when it is detected based on monitor data in said monitor mode that abnormality of a monitor object has happened, the fact may be notified to a user, so that the user can learn immediately that abnormality of the monitor object has happened.

Furthermore, although an example has been shown in which the monitor data storage section 111 for storing monitor data is provided in the monitor robot 3, a server may be provided in a company or an agency of crime prevention service and monitor data may be stored in the server. If the monitor data and identification information of a user corresponding to the monitor data are transmitted by the monitor robot 3, and if the monitor data corresponding to the user is presented in response to a request of the user issued through the internet or the like, the user can learn the monitor information easily.

The effects of the invention include the following:

In a monitoring device according to the invention as described above, mode switching means is provided for switching an autonomous mode and a monitor mode. Therefore, the device can determine an behavior based on the feeling in the autonomous mode, and behave like a living thing, giving a friendly feeling to a user as if it were a pet, so that in the monitor mode, a uncomfortable feeling given to the user is small even if it patrols autonomously a monitor area, for example, in the room.

In addition, in a monitoring system utilizing the monitoring device according to this invention, the monitoring device transmits monitor information and identification information on a user corresponding to the monitor information in the monitor mode, and a server provided in a company or an agency of crime prevention service receives to store the transmitted monitor information and identification information on a user, and presents the monitor information corresponding to the user in response to a request of the user issued through the internet or the like. Therefore, the user can learn the monitor information easily.

It will be understood by those of skill in the art that numerous and various modifications can be made without departing from the spirit of the present invention. Therefore, it should be clearly understood that the forms of the present invention are illustrative only and are not intended to limit the scope of the present invention.

What is claimed is:

1. A monitoring device comprising:
an environmental information-sensing unit for sensing information on a surrounding environment;
an environmental information-processing unit for processing the information sensed by the environmental information-sensing unit, thereby recognizing the surrounding environment;
an emotion-generating unit for generating emotions based on the surrounding environment recognized by the environmental information-processing unit;
a mode-selecting unit for selecting an autonomous mode in which the device behaves autonomously or a monitoring mode in which the device monitors the surrounding environment;
a behavior-determining unit for determining a behavior in the selected mode based on the surrounding environment recognized by the environmental information-processing unit and the emotions generated by the emotion-generating unit; and
a behavior-activating unit for activating the behavior determined by the behavior-determining unit.

2. The monitoring device according to claim 1, further comprising a monitoring condition-inputting unit for inputting monitoring conditions into the behavior-determining unit.

3. The monitoring device according to claim 1, further comprising a data-transmitting unit for transmitting monitoring data acquired by the environmental information-processing unit in the monitoring mode, to a memory or a designated place.

4. The monitoring device according to claim 3, wherein the behavior-determining unit is configured to transmit monitoring data in the monitoring mode when the emotions generated by the emotion-generating unit exceed pre-selected threshold levels.

5. The monitoring device according to claim 1, further comprising a communication interface for communicating with a designated user to receive commands for the mode-selecting unit.

6. The monitoring device according to claim 2, further comprising a communication interface for communicating with a designated user to receive commands for the monitoring condition-inputting unit.

7. The monitoring device according to claim 3, further comprising a communication interface for communicating with a designated user to transmit the monitoring data.

8. A method for monitoring a surrounding environment using a device comprising:
sensing information on a surrounding environment by an environmental information-sensing unit provided in the device;
processing the sensed information by an environmental information-processing unit provided in the device, thereby recognizing the surrounding environment;
generating emotions by an emotion-generating unit provided in the device based on the recognized surrounding environment;
selecting an autonomous mode in which the device behaves autonomously or a monitoring mode in which the device monitors the surrounding environment;
determining a behavior in the selected mode by a behavior-determining unit provided in the device based on the recognized surrounding environment and the generated emotions; and
activating the determined behavior by a behavior-activating unit provided in the device.

9. The method according to claim 8, further comprising inputting monitoring conditions into the behavior-determining unit.

10. The method device according to claim 8, further comprising transmitting monitoring data acquired by the environmental information-processing unit in the monitoring mode, to a memory or a designated place.

11. The method according to claim 10, wherein monitoring data in the monitoring mode is transmitted when the emotions generated by the emotion-generating unit exceed pre-selected threshold levels.

12. The method according to claim 8, further comprising communicating with a designated user to receive commands for the mode-selecting unit via a communication interface.

13. The method according to claim 9, further comprising communicating with a designated user to receive commands for the monitoring condition-inputting unit via a communication interface.

14. The method according to claim 10, further comprising communicating with a designated user to transmit the monitoring data via a communication interface.

15. A monitoring device characterized by comprising: environmental information acquisition means for acquiring information on a surrounding environment; environment recognition means for recognizing the surrounding environment based on the information acquired by the environmental information acquisition means; feeling production means for producing feelings based on the surrounding environment recognized by the environment recognition means; behavior determination means for determining a behavior based on the feeling produced by the feeling production means; and mode switching means for switching an autonomous mode and a monitor mode; and
wherein said behavior determination means determines the behavior in response to the switching result of said mode switching means.

16. The monitoring device according to claim 15, wherein in said monitor mode, said environmental information acquisition means acquires environmental information on an image, a sound or the like as information on said surrounding environment.

17. The monitoring device according to claim 15, wherein said monitor mode includes an autonomous monitor mode in which monitoring is performed autonomously under predetermined monitor conditions, and a remote operation mode in which monitoring is performed according to user's remote operation.

18. The monitoring device according to claim 17, comprising, in said remote operation mode, selection-of-behavior request means for requesting a user to select an behavior, and selected behavior determination means for determining an behavior based on the selection result selected by the user through said selection-of-behavior request means.

19. The monitoring device according to claim 17, comprising monitor condition input means through which a user inputs said monitor conditions.

20. The monitoring device according to claim 17, wherein said monitor conditions include at least one of a date, a time interval, a degree of change in the surrounding environment, and a patrol route.

21. The monitoring device according to claim 15, wherein said switching means switches the autonomous mode and the monitor mode based on the recognition result by said environment recognition means.

22. The monitoring device according to claim 15, comprising person identification information fetching means for fetching information on a voice, a face image or the like by which a person can be identified, from among surrounding environments recognized by said environment recognition means; and user identification means for determining, based on said information, whether or not a person whose information is fetched by the person identification information fetching means is a user who has been registered in advance; and wherein said behavior determination means determining an behavior based on the feeling produced by said feeling production means and the identification result by said user identification means.

23. The monitoring device according to claim 15, comprising feeling identification information fetching means for fetching information on a voice, an expression or the like by which feelings can be identified, from among surrounding environments recognized by said environment recognition means; said behavior determination means determining an behavior based on the feeling produced by said feeling production means and the information fetched by said feeling identification information fetching means.

24. The monitoring device according to claim 15, comprising, in said autonomous monitor mode, power saving means for stopping power supply to a given part according to monitor conditions.

25. The monitoring device according to claim 15, comprising storage means for storing information on the surrounding environment recognized by said environment recognition means in said monitor mode; retrieval condition input request means for requesting a user to input retrieval conditions; and a presentation device for presenting the information stored in said storage means, based on retrieval conditions inputted by the user through the retrieval condition input request means.

26. The monitoring device according to claim 15, comprising monitor information notification means for notifying monitor information as the recognition result by said environment recognition means in said monitor mode, to a user through a communication line.

27. The monitoring device according to claim 15, comprising abnormality occurrence detection means for detecting occurrence of abnormality of a monitor object, based on monitor information as the recognition result of said environment recognition means in said monitor mode; and abnormality occurrence notification means for notifying a user that the abnormality occurrence detection means has detected occurrence of abnormality of the monitor object.

28. A monitoring system characterized by comprising a monitoring device and a server, said monitoring device comprising environmental information acquisition means for acquiring information on a surrounding environment; environment recognition means for recognizing the surrounding environment based on the information acquired by the environmental information acquisition means; feeling production means for producing an feeling based on the surrounding environment recognized by the environment recognition means; behavior determination means for determining an behavior based on the feeling produced by the feeling production means; mode switching means for switching an autonomous mode and a monitor mode; and transmission means for transmitting the monitor information recognized by said environment recognition means and identification information on a user corresponding to the monitor information, in said monitor mode, and said server comprising storage means for receiving, for storage, the monitor information transmitted by said transmission means and the identification information on the user; and presentation means for presenting monitor information corresponding to the user in response to a request of the user.
